(19) United States
(12) Patent Application Publication
(10) Pub. No.: US 2002/0080575 A1
(43) Pub. Date: Jun. 27, 2002

(54) Network switch-integrated high-density multi-server system

(76) Inventors: Kwanghee Nam, Pohang (KR); John Milburn, Palo Alto, CA (US)

Correspondence Address: BEYER WEAVER & THOMAS LLP, P.O. BOX 778, BERKELEY, CA, 94704-0778, US

(21) Appl. No.: 09/770,630

(22) Filed: Jan. 25, 2001

Related U.S. Application Data
(60) Provisional application No. 60/253,601, filed on Nov. 27, 2000.
(60) Provisional application No. 60/260,509, filed on Jan. 8, 2001.

(51) Int. Cl. G06F 1/16

(52) U.S. Cl. 361/686

(57) ABSTRACT

A multi-server system includes single board computers, a network interface for each of the single board computers, network switching circuitry, and a housing. The network switching circuitry selectively facilitates data transmissions among the plurality of single board computers through the network interfaces. The network switching circuitry communicates with the single board computers through at least one back plane. A server architecture includes multiple instances of the multi-server system, interconnected via at least one external network port of each. The server architecture includes external network switching circuitry for selectively facilitating data transmission among the multi-server systems and an external server external to the server architecture.

### CROSS-REFERENCE TO RELATED APPLICATIONS

This application claims priority under 35 U.S.C. 119(e) from U.S. Provisional Patent Applications Ser. No. 60/253,601 filed on Nov. 27, 2000, naming Keum-Jung Lee, et al. as inventors and titled “NETWORK SWITCH-INTEGRATED HIGHDENSITY MULTI-SERVER SYSTEM”; and No. 60/260,509 filed on Jan. 8, 2001, naming Kwanghee Nam, et al. as inventors and titled “NETWORK SWITCH-INTEGRATED HIGH-DENSITY MULTI-SERVER SYSTEM.” These applications are incorporated herein by reference for all purposes.

### BACKGROUND OF THE INVENTION

The present invention relates to multi-server systems. More particularly, the invention relates to a high-density multi-server system with an integrated network switch.

Internet Service Providers (ISPs), Application Service Providers (ASPs), Management Service Providers (MSPs), dot-coms, and large enterprises are demanding cost-effective, easy-to-use, reliable, scalable, and rackable Internet server solutions to provide dedicated functions for their businesses. Currently, these service providers typically use a large number of powerful, expensive servers to support their mission-critical services. These servers are connected to network switches, hubs or routers for exchanging information between clients and servers. As the number of users increase, these service providers must increase the number of servers and networking equipment in order to satisfy the increased processing and communication needs. The cost of doing this is enormous and the service providers are desperately looking for cost-effective and scalable solutions.

Recently, server vendors have introduced “Internet servers” to satisfy the demands of these service providers. The Internet servers are typically segmented into two distinct categories: 1) multifunction servers designed for small offices and small business, and 2) dedicated function servers optimized for ISPs, ASPs, MSPs, dot-coms, and large enterprises. These servers are mostly standard Intel architecture servers (SIASs), and are rack optimized. The rack optimized SIASs are categorized as follows:

Uniprocessor servers with a 1U height rating (approximately 1.75 in. in height),

Two-way capable servers with a U rating of three or less (approximately 5.25 in. or less in height),

Four way and six-way capable servers with a U rating of four or less (approximately 7 in. in height), and

Eight-way capable servers with a U rating of eight or less (approximately 14 in. in height).

The Internet servers are typically co-located in Internet data centers (e.g., Exodus, Abovenet). The charging scheme used by these data centers to their clients (e.g., ISPs, ASPs) is based on the cubic feet of space. When making hardware solution decisions, ISPs and ASPs are now looking at not only the processing power but also the price per cubic foot of space or, in the case of Web hosting companies, revenue per cubit foot. Thus, the form factor of these Internet servers has become a very (if not the most) important attribute in reducing the total deployment cost.

The solutions that those server vendors have introduced so far have been two-way capable servers in 1U. These servers are not very cost-effective or scalable. That is, additional servers require more, separate networking equipment. Multi-way CPUs are typically connected through a single shared bus, and hence each CPU lacks its own autonomy and communication resource contention exists.

In view of these and other issues, it would be highly desirable to have a multi-server system allowing much scalability, cost-effectiveness, and reliability.

### SUMMARY OF THE INVENTION

The present invention provides a solution to the above-described problems. Specifically, the multi-server system according to the present invention has combined network switch and server technologies into a single integrated box. In the multi-server system according to various specific embodiments of the present invention, tens of single board computers (SBCs) are connected through a network switch (such as 10/100/1000 Mbps Ethernet) instead of a shared PC system bus. Users can use each SBC as a standalone, autonomous server or can cluster multiple SBCs and use the cluster as a single server. The multi-server system of the present invention is very scalable as users can use 1) a single SBC in the multi-server system of the invention as a server, 2) multiple SBCs in the multi-server system of the invention as a server, 3) the entire multi-server system of the present invention as a server, 4) a rack of the multi-server systems of the invention as a server, or 5) racks of the multi-server system of the invention as a server. The density of CPUs in the multi-server system of the invention is an order of magnitude better than existing solutions offered by conventional servers. Thus, the system according to the present invention is much more cost-effective.

According to various embodiments, the system of the present invention is very reliable by applying the hot-swappable SBC, redundant power supply, redundant network switch, and redundant cooling fan technologies in the multi-server system of the invention. Furthermore, the multi-server system of the invention itself is hot-swappable. The system of the present invention is very flexible in a sense that users can use each SBC as a multifunction server or as a dedicated function server. Users can use some SBCs in the multi-server system of the invention as multifunction servers and other SBCs as dedicated function servers. Further, users can use each multi-server system of the invention as a multifunction server or as a dedicated function server.

In a specific embodiment of the invention, a server includes a plurality of single board computers, one or two network interfaces for each of the single board computers, network switching circuitry, and a housing for enclosing the single board computers and the network switching circuitry. The network switching circuitry selectively facilitates data transmissions among the plurality of single board computers through the network interfaces. The multi-server system of the present invention includes multiple external network ports for communicating with other servers external to the housing and the Internet.

In another specific embodiment, the network switching circuitry communicates with the plurality of the single board computers through at least one back plane. The back plane includes two signal planes, and multiple power planes which are disposed between the signal planes. The single board computers may be arranged on the back plane in at least one row of parallel single board computers.

In still another specific embodiment, each network interface of the multi-server system according to the present invention includes an Ethernet controller. The Ethernet controllers are coupled with each other by a transformer, a capacitor, or a data buffer; or alternatively, are coupled directly without an Ethernet transceiver.

In still another specific embodiment, the multi-server system according to the present invention includes a plurality of the servers, each of which has the plurality of single board computers, the network interface for each of the single board computers, network switching circuitry, the back plane, and the housing for enclosing the single board computers, the network switching circuitry and the back plane. The servers in the multi-server system communicate with each other using the Ethernet protocol. The multi-server system may include external switching circuitry for selectively facilitating data transmissions.

In a specific embodiment of a cooling device for use with the present invention, a heat pipe is thermally coupled to an integrated circuit. The cooling device includes a plurality of cooling fins thermally coupled to the heat pipe, thereby removing heat from the integrated circuit by a cooling fan.

These and other features and advantages of the invention will be described in more detail below with reference to the associated drawings.

### BRIEF DESCRIPTION OF THE DRAWINGS

FIG. 1 is a perspective view of a specific embodiment of a multi-server system according to the present invention.

FIG. 2 is an enlarged view of the single board computer for use with the present invention.

FIG. 3 is a perspective view of another configuration for the multi-server system of the present invention.

FIG. 4 is a perspective view of a still another configuration for the multi-server system of the present invention.

FIG. 5 is an exploded view of the back planes for use with the present invention.

FIG. 6 is a cross-sectional view of the back planes shown in FIG. 5.

FIG. 7 is a block diagram of the multi-server system according to the present invention.

FIG. 8 is a block diagram of the back plane for use with the multi-server system according to the present invention.

FIG. 9 is a block diagram of the single board computer for use with the multi-server system according to the present invention.

FIG. 10 is a block diagram of the network switch card for use with the multi-server system according to the present invention.

FIG. 11 is a block diagram illustrating the Ethernet connection between the Ethernet controllers by transformers for use with the multi-server system according to the present invention.

FIG. 12 is a block diagram illustrating the Ethernet connection between the Ethernet controllers by capacitors for use with the multi-server system according to the present invention.

FIG. 13 is a block diagram illustrating the Ethernet connection directly between the Ethernet controllers without the Ethernet controllers for use with the multi-server system according to the present invention.

FIG. 14 is a block diagram illustrating the Ethernet connection directly between the Ethernet controllers without the Ethernet controllers for use with the multi-server system according to the present invention.

FIG. 15 is a top view of another embodiment of the multi-server system according to the present invention.

FIG. 16 is a block diagram of the embodiment of FIG. 15 in the normal operation state.

FIG. 17 is a block diagram of the embodiment of FIG. 15 in a system failure state, where the network switch card does not function properly.

FIG. 18 is a front view of a multi-server system according to the present invention.

FIG. 19 is a front view of a multi-server system according to the present invention.

FIG. 20 is a front view of a multi-server system according to the present invention.

FIG. 21 is a front view of a multi-server system according to the present invention.

FIG. 22 is a diagram illustrating how to reset the single board computers selectively by a remote manager in the embodiments of the multi-server system according to the present invention.

FIG. 23 is a block diagram of the remote power resetting control for use with the multi-server system according to the present invention.

FIG. 24 is a block diagram of another embodiment of FIG. 15 in the normal operation state.

FIG. 25 is a block diagram of another embodiment of FIG. 15 in a system failure state, where the network switch card does not function properly.

### DETAILED DESCRIPTION OF THE PREFERRED EMBODIMENTS

The present invention will now be described in detail with reference to the drawings, wherein like elements are referred to with like reference labels throughout.

### 1. MECHANICAL STRUCTURE

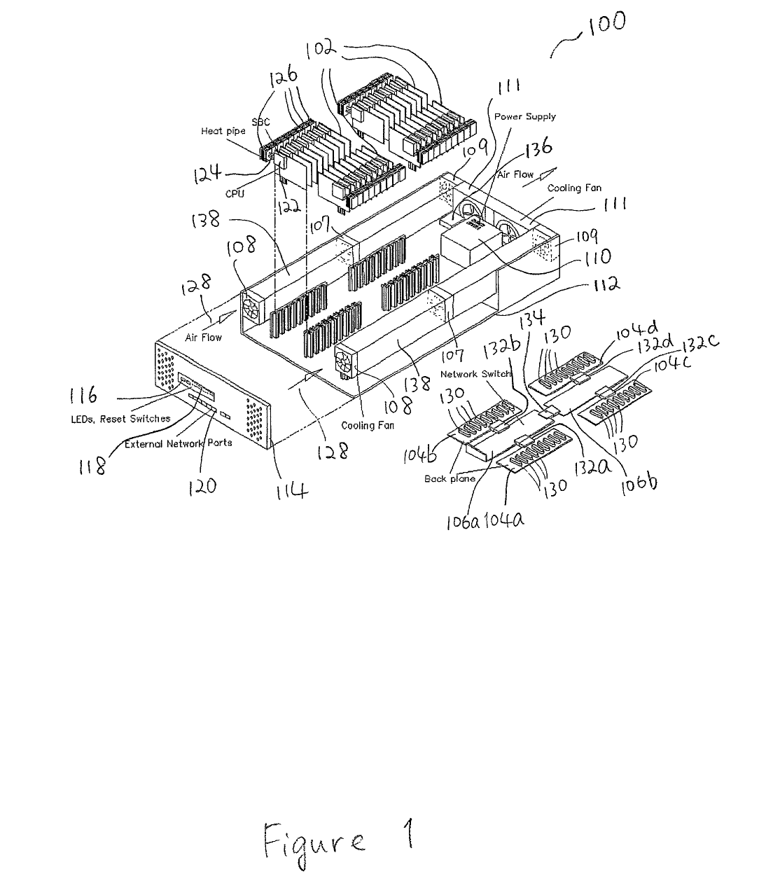

FIG. 1 is a perspective view of a specific embodiment of a multi-server system 100 according to the present invention. In this embodiment, the multi-server system 100 includes 36 single board computers (SBCs) 102 (nine single board computers for each back plane), four back planes 104a, 104b, 104c and 104d, two network switch cards 106a and 106b, two cooling fans 108, and a power supply 110 in a housing 112. Reset switches 116 for resetting the single board computers 102, light emitting diodes (LEDs) 118 for indicating status of various functions of the system 100, and external network ports 120 are mounted on a front panel 114 of the housing 112.

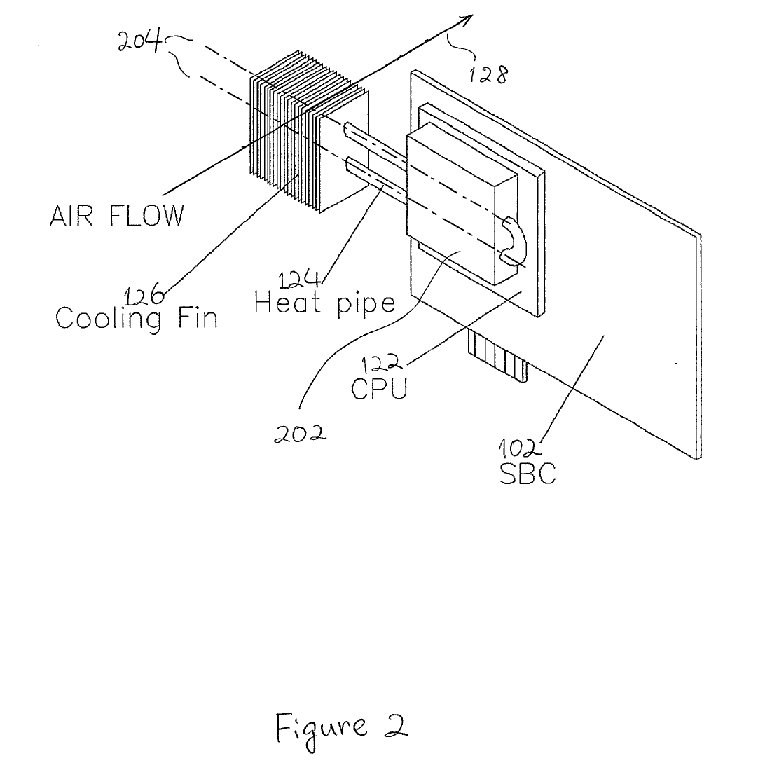

Each single board computer 102 has a CPU (central processing unit) 122 thereon. A heat pipe 124 thermally couples the CPU 122 and cooling fins 126. The cooling fans 108 provide cooling airflow 128 over the cooling fins 126. FIG. 2 is an enlarged view of the single board computer 102 for use with the present invention. In a specific embodiment, a heat sink 202 is physically and thermally coupled to the CPU 122 mounted on the single board computer 102. The heat pipe 124 thermally couples the heat sink 202 and the cooling fins 126. An axis 204 of the heat pipe 124 is substantially normal to the cooling fins 126. The heat pipe 124 contains liquid coolant.

Heat dissipated by the CPU 122 travels through the heat sink 202, the heat pipe 124, and the cooling fins 126. The cooling fans 108 provide the cooling airflow 128 over the cooling fins 126 in air ducts 138. The cooling airflow 128 flows through the cooling fins 126 in a direction which is substantially parallel to the cooling fins 126. The cooling fins 126 are aligned within the air ducts 138 so that the forced cooling airflow by the cooling fans 107, 108 and 109 can efficiently remove heat from the cooling fins 126. The cooling fans 111 remove heat from other components, such as the single board computers 102, the network switch cards 106a and 106b, and the power supply 110. The air ducts 138 may be made from solid steal or aluminum plates. It is noted that the number of the cooling fans 107, 108 and 109 is not limited to three for each of the air ducts 138 as shown in FIG. 1.

Referring back to FIG. 1, nine of the single board computers 102 are mechanically and electrically connected to one of the single back planes 104a, 104b, 104c and 104d by nine card connectors 130. The two back planes 104a and 104b are mechanically and electrically connected to the network switch card 106a by connectors 132a and 132b on opposite ends of the network switch card 106a. Similarly, the two back planes 104c and 104d are mechanically and electrically connected to the network switch card 106b by connectors 132c and 132d on opposite ends of the network switch card 106b.

The two network switch cards 106a and 106b are mechanically and electrically connected with each other by a connector 134. The single board computers 102 are substantially parallel to each other. The back planes 104a, 104b, 104c and 104d, and the network switch cards 106a and 106b are substantially on the same plane. Thus, in this embodiment, each of the single board computers 102 is perpendicular to the back planes 104a, 104b, 104c and 104d, and the network switch cards 106a and 106b. Since the single board computers 102, and the network switch cards 106a and 106b are attached to the back planes 104a, 104b, 104c and 104d by connectors, a user can easily attach and detach them for the purpose of diagnosis and maintenance, and for fitting the performance requirements.

The rear portion of the housing 112 encloses the power supply 110, and hard disks (HDDs) 136. The HDDs 136 may be connected to one or more SBCs 102 in the multi-server system of the invention for the purpose of SBC booting and local data storage. The external network ports 120 which may include connectors for 100Base-TX, and 1000Base-SX/LX/CX are provided on the front panel 114 for connections to external devices, such as the multi-server system of the invention, Intemet/Intranet routers, switches and file servers.

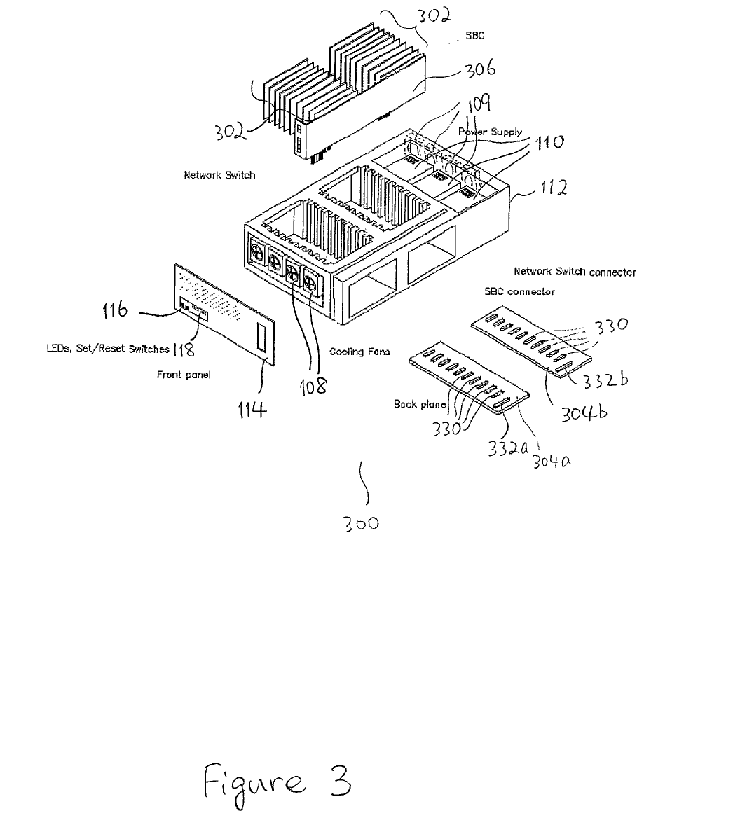

FIG. 3 is a perspective view of another configuration for a multi-server system 300 of the present invention. In the embodiment shown in FIG. 3, the single board computers 302 are substantially parallel to a network switch card 306. The single board computers 302 are mechanically and electrically connected to back planes 304a and 304b by connectors 330. The network switch card 306 is mechanically and electrically connected to the back planes 304a and 304b by connectors 332a and 332b. The airflow from the cooling fans 108 directly remove heat from each heat sink block mounted on the CPU of each single board computer 302. Although the embodiment of FIG. 3 does not include cooling fins attached to the single board computers 302, cooling fins may be thermally coupled to the CPUs of the single board computers 302 through the heat pipes as illustrated in FIG. 1.

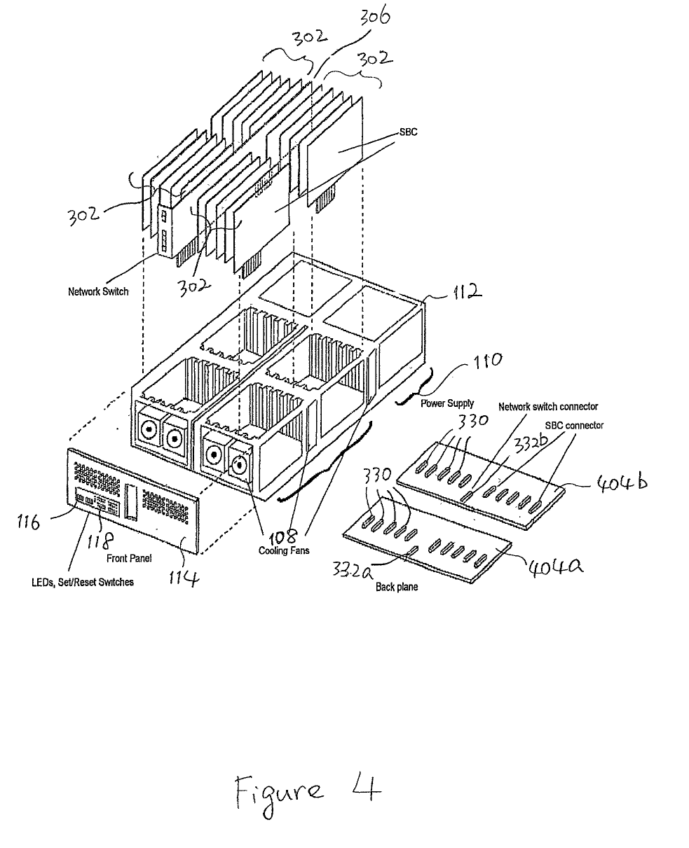

FIG. 4 is a perspective view of a still another configuration for the multi-server system 300 of the present invention. The embodiment of the present invention shown in FIG. 4 utilizes back planes 404a and 404b on which the connectors 330 are symmetrically arranged with respect to the connectors 332a and 332b. Such an arrangement may be desirable where, for example, signal skew associated with individual bus lines on the back planes 404a and 404b is an issue.

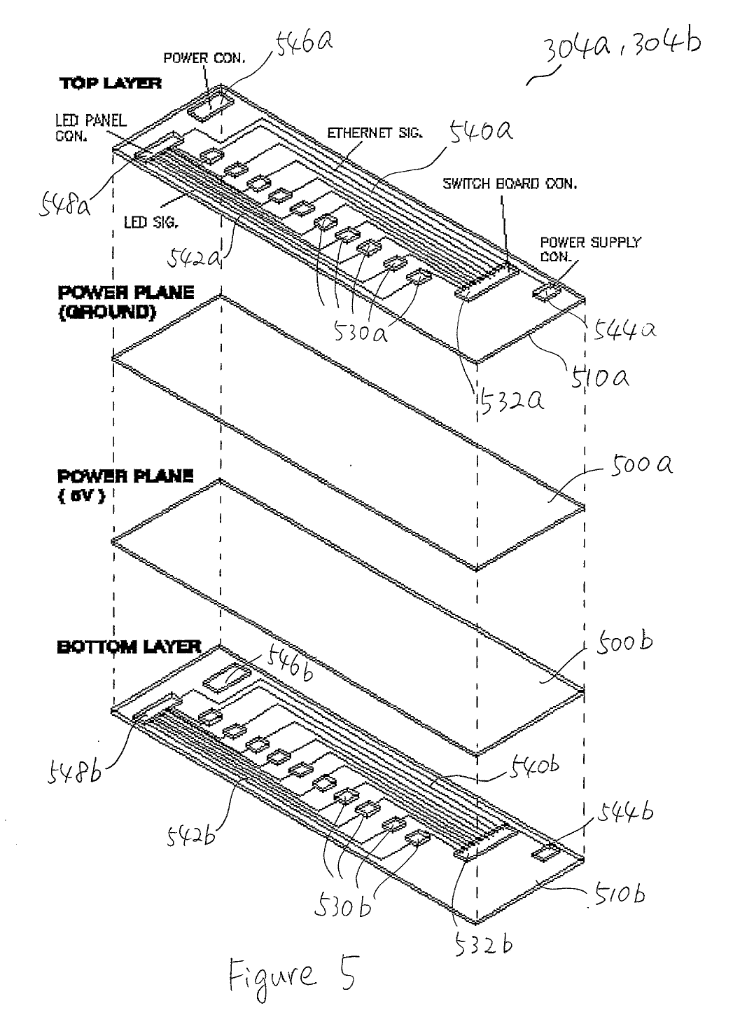

FIG. 5 is an exploded view of the back planes 304a and 304b for use with the present invention. Each of the back planes 304a and 304b includes a power plane 500a for supplying ground level (e.g., 0 volt), a power plane 500b for power supply voltage (e.g., +5 volt), a top layer 510a including conductive patterns for signal, and a bottom layer 510b including conductive patterns for signal. The top layer 510a and the bottom layer 510b are collectively referred to as “signal planes” 510a and 510b in this specification. The structure of the layers of the back planes 304a and 304b are the same with each other except that specific patterns of the back planes 304a and 304b may be modified depending on component arrangement on the back planes 304a and 304b.

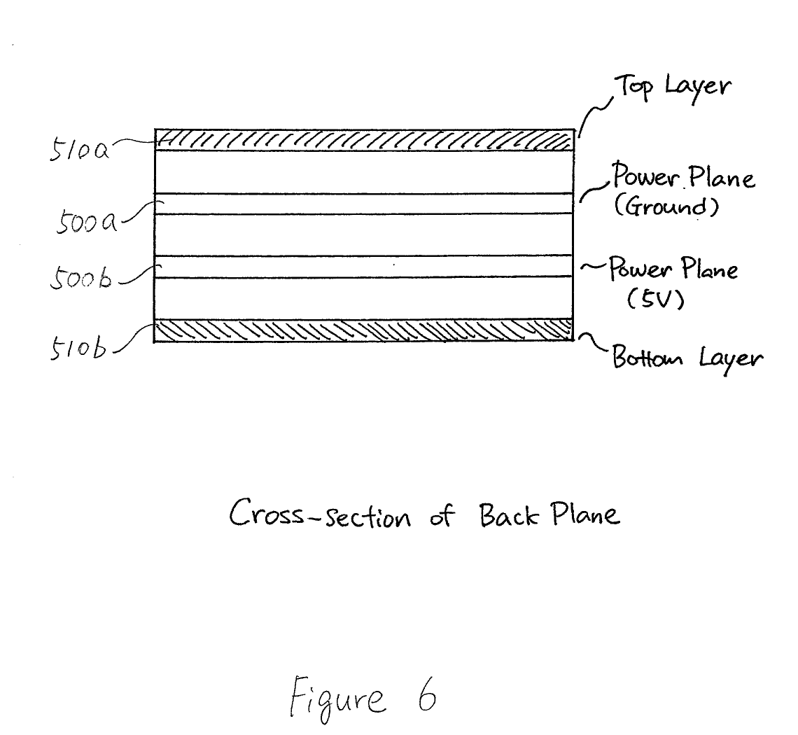

The top layer 510a and the bottom layer 510b include conductive patterns 530a and 530b for the connectors 330; conductive patterns 532a and 532b for the connectors 332a; conductive patterns 540a and 540b for Ethernet data signal; conductive patterns 542a and 542b for the LEDs 118; conductive patterns 544a and 544b for power supply connectors; conductive patterns 546a and 546b for the power planes 500a and 500b; and conductive patterns 548a and 548b for LED connectors, respectively. FIG. 6 is a cross-sectional view of the back planes 304a and 304b shown in FIG. 5.

It will be understood that the general layer structure shown in FIGS. 5 and 6 may also be used for the back planes 104a, 104b, 104c and 104d; and 404a and 404b. In the back planes for use with the present invention, the power planes 500a and 500b are disposed between the signal planes 510a and 510b. Specifically, the signal planes 510a and 510b are disposed on the top and bottom surfaces to reduce the signal delay due to high permeance of the printed circuit board material. Further, Ethernet transmission lines and Ethernet receiving lines are separated by the power planes 500a and 500b, thus minimizing the cross talk between transmission and receiving lines. In other words, all transmission lines (e.g., T×D lines) are disposed on the signal plane 510a, and all receiving lines (e.g., R×D lines) are disposed on the signal plane 510b. Conversely, the transmission lines may be on the signal planes 510b, and the receiving lines may be on the signal planes 510a.

It is noted that the back planes 304a and 304b may includes a plurality of top layers and a plurality of bottom layers, which are separated by the power planes 500a and 500b. For example, the back planes 304a and 304b may includes two top layers for signal lines in the position of the top layers 510a, and two bottom layers for signal lines in the position of the top layers 510b. In this case, the back planes 304a and 304b are six-layer printed circuit boards. Also, it is noted that the back planes 304a and 304b may includes power planes more than two. For example, four power planes may be used in the position of the power planes 500a and 500b.

The back planes described above referring to FIGS. 1-6 typically include printed circuit boards. However, it will be understood that the back planes may include, for example, optical fibers for data transmissions. It is also noted that the signal planes 510a and 510b may be three or more planes. For example, the power planes 500a and 500b may be disposed between two top layers and two bottom layers which include signal lines.

### 2. ELECTRICAL STRUCTURE

FIG. 7 is a block diagram of a specific embodiment of a multi-server system 100 according to the present invention. The block diagram illustrated in FIG. 7 may be utilized in combination with any mechanical and electrical structure of the embodiments described referring to FIGS. 1-6. The multi-server system 100 includes the single board computers 102-1, 102-2, . . . , and 102-n which are electrically connected to the network switch card 106 by Ethernet signal lines 702 for data transmissions. The Ethernet signal lines 702 may include signal lines for Ethernet T×D/R×D data, MII (Media Independent Interface), RMII (Reduced MII), GMII (Gigabit MII), and SMII (Serial MII). In the case of using the Ethernet T×D/R×D data, each line of the Ethernet signal lines 702 in FIG. 7 represents a set of two T×D lines and two R×D lines.

The back plane 104 may be divided into two or more back planes to accommodate a large number of the single board computers 102 as shown in FIG. 1 (the back planes 104a-104d), and FIG. 3 (the back planes 304a and 304b).

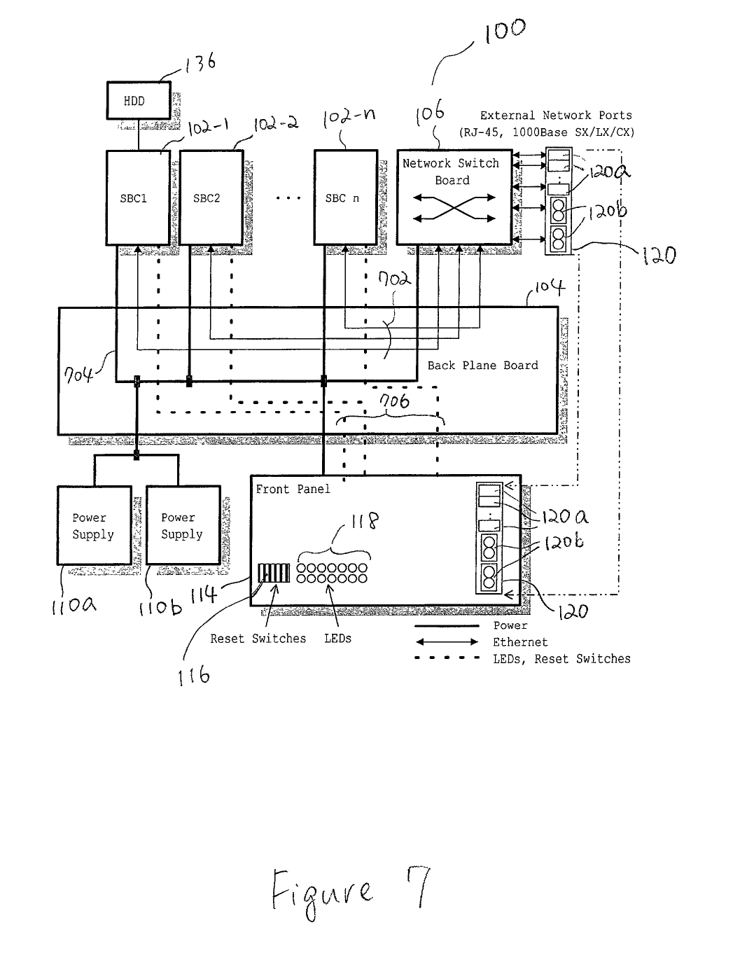

FIG. 8 is a block diagram of a specific embodiment of a back plane 104 for use with the multi-server system 100 according to the present invention. The back plane 104 provides power lines 704, through which the power supplies 110a and 110b (collectively referred to as 110 in, for example, FIG. 1) supply electrical power to the single board computers 102, the network switch card 106, and the front panel 114. The back plane 104 provides lines 706 for controlling the reset switches 116, and the LEDs 118. As described referring to FIG. 6, the power lines 704 are provided on the power planes 500a and 500b, which are disposed between the signal planes 510a and 510b; and the Ethernet signal lines 702 and the control lines 706 are provided on the signal planes 510a and 510b.

The back plane 104 further includes the connectors 330 for coupling the single board computers 302 to the back plane 104 mechanically and electrically; the connector 332 for coupling the network switch card 306 to the back plane 104 mechanically and electrically; a connector 802 for the reset switches 116 and the LEDs 118; and a connector 804 for receiving electric power from the power supplies 110a and 110b.

Referring back to FIG. 7, each of the single board computers 102-1, 102-2, . . . , 102-n (collectively referred to as 102, for example, in FIG. 1) includes a necessary set of components for processing data and communicating with internal/external functional units such as other single board computers in the housing 112, external servers external to the housing 112. Thus, each of the single board computers 102-1, 102-2, . . . , 102-n is capable of functioning as a stand-alone server by itself, and as a part of the multi-server system 100 for cooperating with other single board computers functioning as servers inside the housing 112, and other servers outside the housing 112.

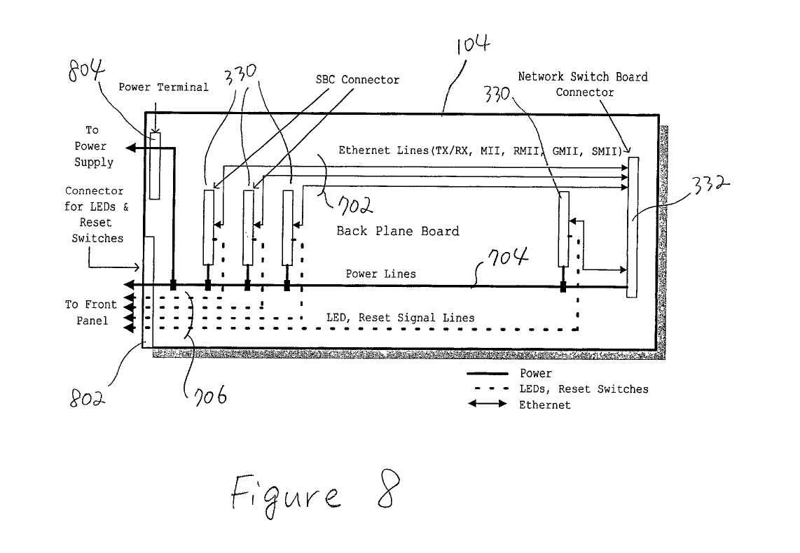

FIG. 9 is a block diagram of a specific embodiment of a single board computer 102 for use with the multi-server system 100 according to the present invention. The single board computer 102 includes the CPU 122, a RAM (random access memory) module 902, and a ROM (read-only memory) 904. The ROM 904 is typically a flash ROM which stores data and instructions for BIOS. The single board computer 102 may include a PCI bus interface, an IDE controller, timers, a DMA controller, and a real time clock.

Unlike typical CPU boards, the single board computer 102 of FIG. 9 does not include circuitry for peripheral devices such as a floppy disk drive, a video display, keyboards, and a mouse, thus achieving better form factor. It will be understood, however, that any or all of these devices in various combinations may be included on the single board computer 102 without departing from the scope of the present invention. Each of the single board computers 102 has a hot swap function in order to be easily replaced without interrupting the operation of other single board computers 102 in the housing 112 when a hardware/software failure occurs with respect to that specific single board computer. Each of the single board computers 102 has a CPU reset switch thereon.

The network interface 910 includes an Ethernet controller 920 and interface logic controller chipsets 930, which communicate with each other via a bus 925. The Ethernet controller 920 facilitates transmissions of data and instructions to/from the interface logic controller chipsets 930 and the back plane 104 through the bus 925 and the Ethernet signal lines 702, respectively. The two Ethernet controllers 920 may be utilized in a single board computer 102 if a redundant network switch card is employed in the housing 112 to prevent one-point failure. The interface logic controller chipsets 930 capable of controlling memory facilitates transmissions of data and instructions to/from the CPU 122, the RAM module 902, the ROM 904, the Ethernet controller 920, and the HDD 136. Data/instructions are transmitted through an IDE bus 932 and an IDE connector 934. The single board computer 102 includes a watchdog timer 936 for system management purposes. Connectors 940 and 942 mechanically and electrically connect the single board computer 102 to the back plane 104.

The hardware elements in the single board computer 102 may be configured (usually temporarily) in cooperation with associated software to function as a server in a stand-alone manner or in combination with one or more servers including other single board computers within the housing 112, and servers external to the housing 112. For example, instructions for enabling the single board computer 102 to function as a single server or as a part of the multi-server system 100 may be stored in the HDD 136, or the RAM module 902, and executed by the CPU 122.

Referring back to FIG. 7, the network switch card 106 functions as network switching circuitry for selectively facilitating data transmissions among the single board computers 102-1, 102-2, . . . , 102-n through the Ethernet signal lines 702. Also, the network switch card 106 functions as network switching circuitry for selectively facilitating data transmissions with other servers outside the housing 112 through the external network ports 120 enabling data transmissions using the Ethernet protocol. Two or more network switch cards may be utilized for the network switch card 106 to accommodate a large number of the single board computers 102. For example, the multi-server system 100 shown in FIG. 1 employs the two network switch cards 106a and 106b, each of which is connected to two back planes 104a and 104b, and 104c and 104d, respectively. For the purpose of preventing one point failure of a multi-server system carrying a single network switch card (e.g., the multi-server system 300), two network switch cards 106 may be used. Irrespectively of the number of the network switch cards 106, the network switch cards 106 function as network switching circuitry as a whole.

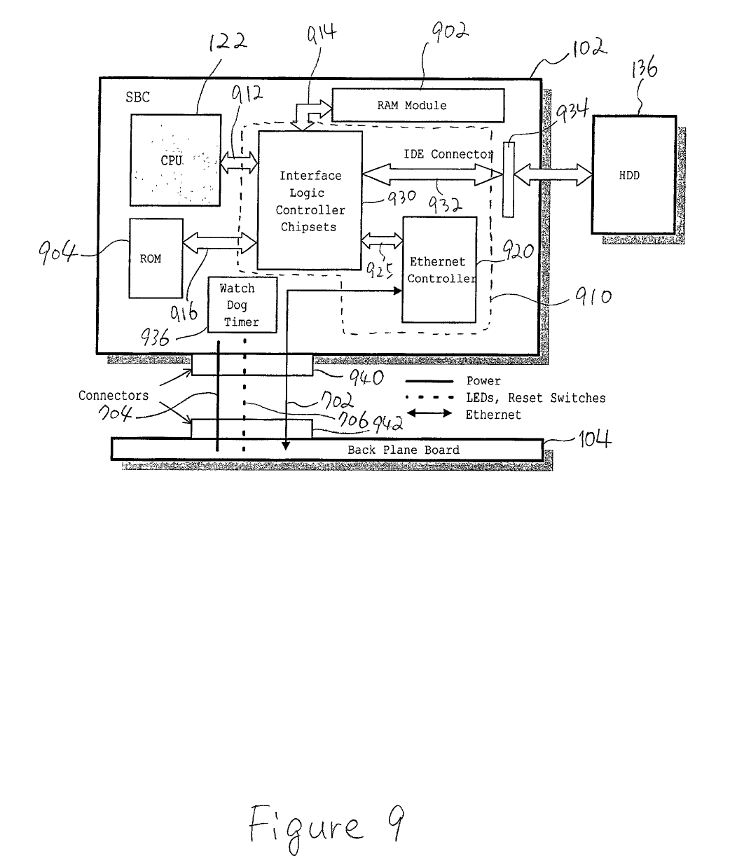

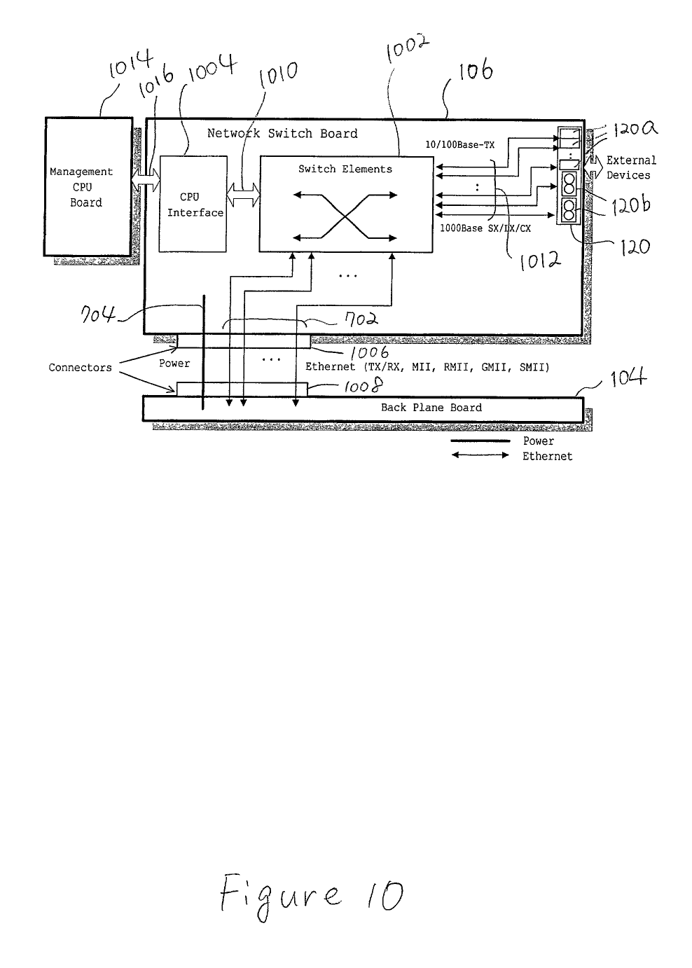

FIG. 10 is a block diagram of a specific embodiment of a network switch card 106 for use with the multi-server system 100 according to the present invention. In one embodiment of the multi-server system 100, the network switch card 106 includes the external network ports 120. The external network ports 120 include ports 120a for unshielded twist cables, and ports 120b for optical fibers. The ports 120a may be RJ-45 connectors for 100Base-TX. The ports 120b may be ports for 1000Base-SX, 1000Base-LX, 1000Base-CX, or 1000Base-TX. The detailed specifications for 100Base-T and 1000Base-T are described in IEEE 802.3 and IEEE 802.3z, respectively, which are incorporated herein by reference in their entirety and for all purposes. In the embodiment shown in FIG. 10, the external network ports 120 are provided on the network switch card 106, and are flush with the front panel 114 for convenience of connecting other servers, such as network routers, switches, and file servers, to the multi-server system 100.

The network switch card 106 includes switch elements 1002 for data switching, and a CPU interface 1004 for interfacing with a management CPU board 1014. The switch elements 1002 facilitates data transmissions with other single board computers 102 through the Ethernet signal lines 702, connectors 1006 and 1008, and the back plane 104; and with external devices external to the housing 112 through Ethernet signal lines 1012 and the external network ports 120. The switch elements 1002 may include, for example, a shared-memory architecture for switching packets. The CPU interface 1004 communicates with the management CPU board 1014 through a bus 1016 for managing switching operation of the switch elements 1002, and receiving management information base (MIB).

The HDD 136 may be connected to at least one of the single board computers 102 through an IDE connector. The HDD 136 functions as a local data storage device for storing boot image as well as other data and files. Thus, the single board computer 102 can be booted from the local HDD 136, or from a remote boot server connected to the system 100.

Each of the reset switches 116 on the front panel 114 is capable of resetting the corresponding one of the single board computers 102. Each of the LEDs 118 on the front panel 114 indicates operation status and power status of corresponding one of the single board computers 102. The dual power supplies 110a and 110b supply sufficient electric power to the components of the system 100 by sharing power load during normal operation. Also, the power supplies 110a and 110b provide fail-safe redundancy when one of them fails to supply the normal power. If one of the power supplies 110a and 110b fails, then the other one can back up automatically.

Each of the single board computers 102 may have an additional Ethernet controller and an additional Ethernet port for connection to a redundant back-up network switch board. Providing two Ethernet ports for each single board computer is advantageous for separating external data traffic to/from the client over the internet, from internal data traffic to/from the file servers or other back-end servers which reside within the multi-server system 100.

FIG. 11 is a block diagram illustrating the Ethernet connection between the Ethernet controllers by transformers for use with the multi-server system 100 according to the present invention. The Ethernet controllers 920a, and 920b are included in the single board computer 102, and the network switch card 106, respectively. The Ethernet controllers 920a and 920b include associated Ethernet transceivers 1100a and 1100b, respectively. The Ethernet controller 920a and the Ethernet transceiver 1100a communicate with each other using one of MII, RMII, SMII, GMII, and 10-bit interface data protocol. Similarly, the Ethernet controller 920b and the Ethernet transceiver 1100b communicate with each other using one of MII, RMII, SMII, GMII, and 10-bit interface data protocol. The Ethernet transceivers 1100a and 1100b communicate with each other using T×D and R×D signals through transformers 1102a, 1102b, 1104a and 1104b, and signal lines 1110. The signal lines 1110 are provided on the back plane 104. The transformers 1102a, 1102b, 1104a and 1104b may be disposed on the corresponding single board computer 102. Alternatively, the transformers 1102a, 1102b, 1104a and 1104b may be disposed on the back plane 104 through which data are transmitted.

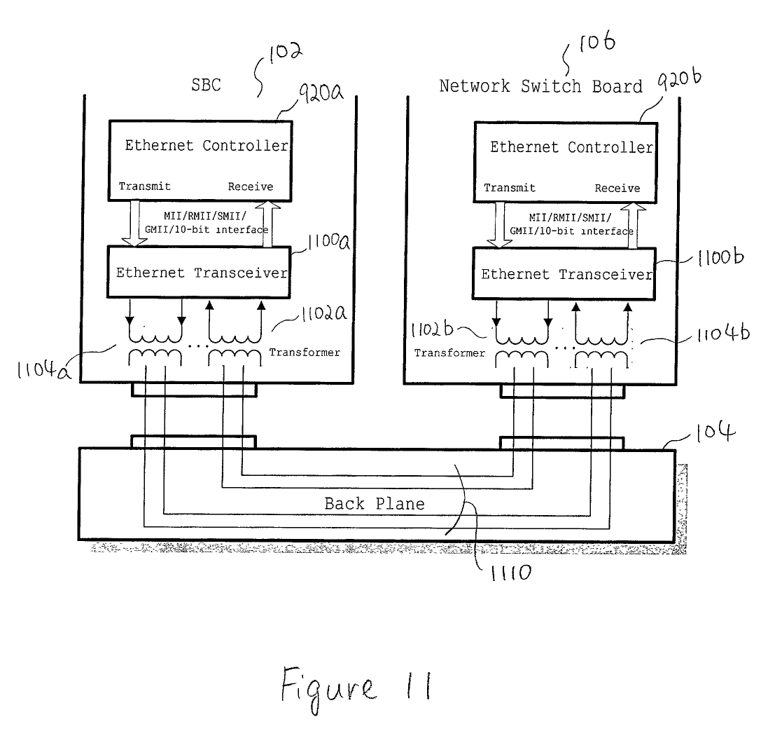

FIG. 12 is a block diagram illustrating the Ethernet connection between the Ethernet controllers by capacitors for use with the multi-server system 100 according to the present invention. Similar to the embodiment of FIG. 11, the Ethernet controller 920a and the Ethernet transceiver 1100a communicate with each other using one of MII, RMII, SMII, GMII, and 10-bit interface data protocol. The Ethernet controller 920b and the Ethernet transceiver 1100b communicate with each other using one of MII, RMII, SMII, GMII, and 10-bit interface data protocol. The Ethernet transceivers 1100a and 1100b communicate with each other using T×D and R×D signals through capacitors 1202a, 1204a, 1206a, 1208a, 1202b, 1204b, 1206b, and 1208b and signal lines 1110. The signal lines 1110 are provided on the back plane 104. The capacitors 1202a, 1204a, 1206a, 1208a, 1202b, 1204b, 1206b, and 1208b may be disposed on the corresponding single board computer 102. Alternatively, the capacitors 1202a, 1204a, 1206a, 1208a, 1202b, 1204b, 1206b, and 1208b may be disposed on the back plane 104 through which data are transmitted.

FIG. 13 is a block diagram illustrating the Ethernet connection directly between the Ethernet controllers without the Ethernet transceivers 1100a and 1100b for use with the multi-server system 100 according to the present invention. The Ethernet controllers 920a and 920b communicate with each other using one of MII, RMII, SMII, GMII, and 10-bit interface data protocol through signal lines 1300. The signal lines 1300 are provided on the back plane 104. The embodiment shown in FIG. 13 are capable of transmitting data without the Ethernet transceivers, the transformers, and the capacitors, thus realizing more simplified configuration of the system 100.

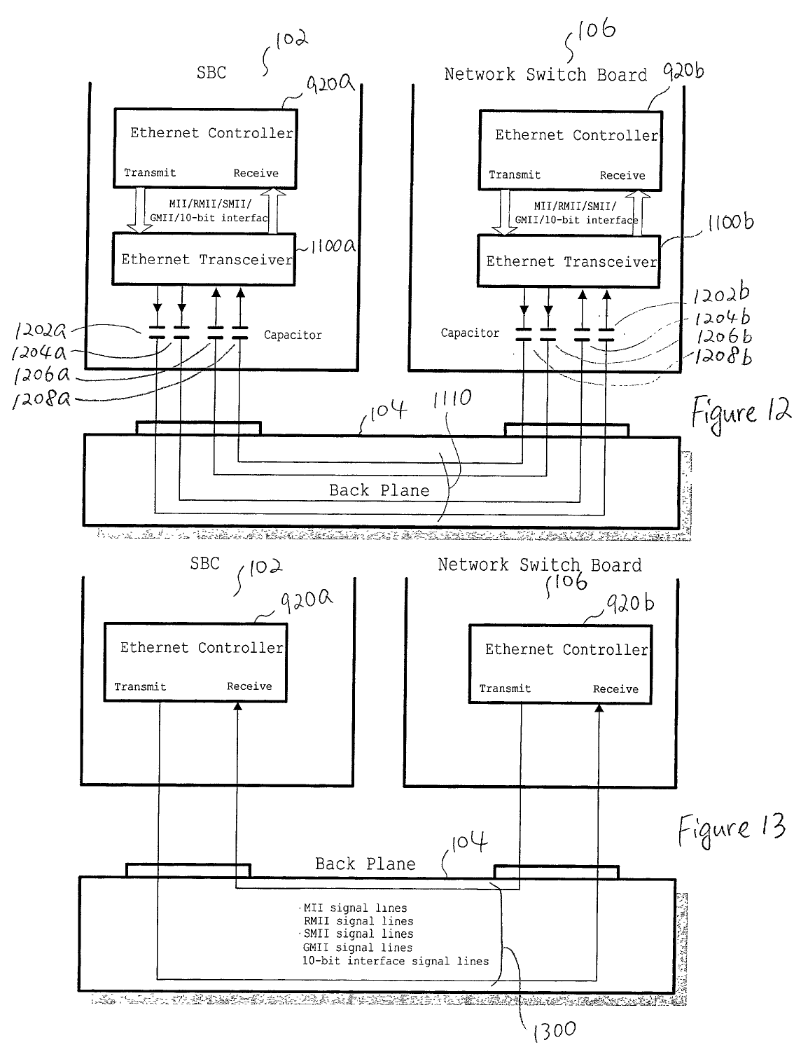

FIG. 14 is a block diagram illustrating the Ethernet connection directly between the Ethernet controllers without the Ethernet transceivers 1100a and 1100b for use with the multi-server system 100 according to the present invention. As illustrated in FIG. 14, the Ethernet controllers 920a and 920b communicate with each other using one of MII, RMII, SMII, GMII, and 10-bit interface data protocol through interface logic/buffer units 1400a and 1400b, and the signal lines 1300. The interface logic/buffer units 1400a and 1400b improve matching between the Ethernet controllers 920a and 920b, and the signal lines 1300. The interface logic/buffer units 1400a and 1400b may be disposed on the corresponding single board computer 102. Alternatively, the interface logic/buffer units 1400a and 1400b may be disposed on the back plane 104 through which data are transmitted.

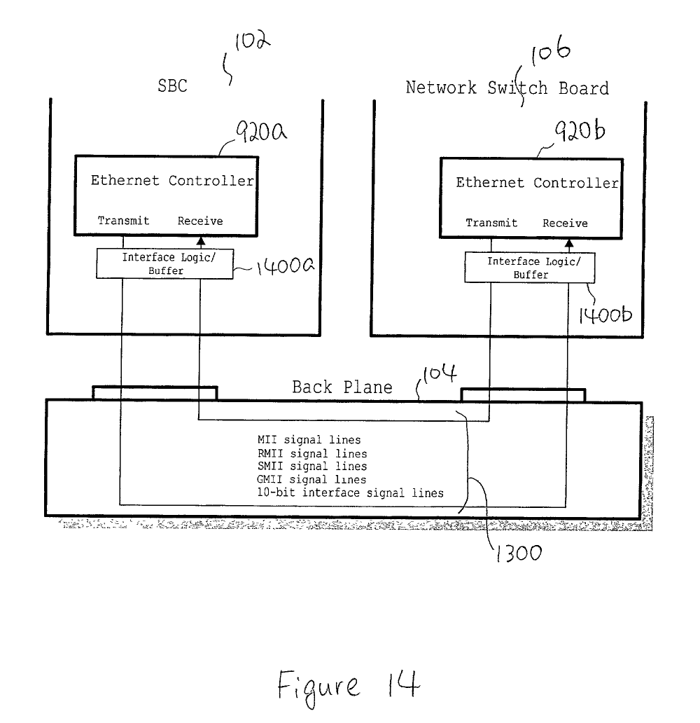

FIG. 15 is a top view of another embodiment of the multi-server system 100 according to the present invention. In this embodiment, the system 100 includes the single board computers 1500, two network switch cards 1510 and 1520, and four fan modules 1501-1504 in the housing 112. The two network switch cards 1510 and 1520 are provided for the fail-safe purpose to achieve higher reliability and availability of the system 100. As a result, the system 100 is capable of functioning in normal operation even in the case of the failure of one of the network switch cards 1510 and 1520. The fan modules 1501-1504 provide cooling airflow 1506 over the single board computers 1500. The cooling airflow 1506 flows through the single board computers 1500 in a direction which is substantially parallel to the single board computers 1500.

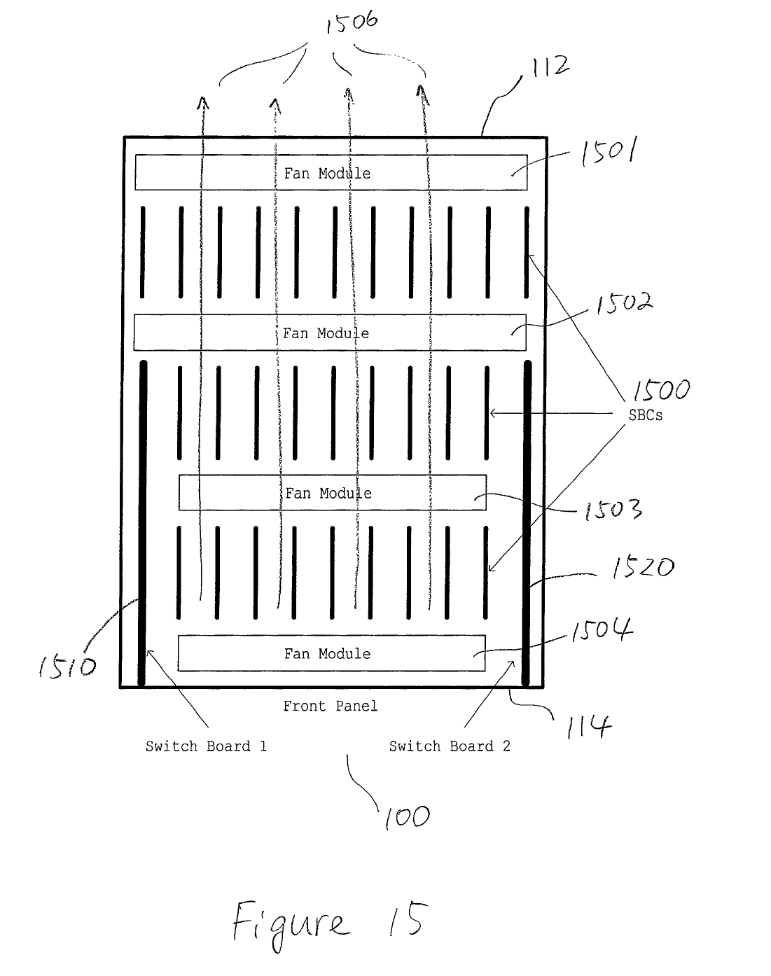

FIG. 16 is a block diagram of the embodiment of FIG. 15 in the normal operation state. The multi-server system 100 includes the single board computers 1500, and the network switch cards 1510 and 1520. External switches 1610 and 1620 are switches external to the multi-server system 100 for connection to the Internet and the Intranet. In the embodiment of FIG. 16, the single board computers 1500 communicate with the two network switch cards 1510 and 1520 through the back plane 104. A signal line 1614 connects the network switch card 1510 to the external switch 1610, through which an external network 1612 (e.g., a file server or the Intranet) can be accessed. A signal line 1624 connects the network switch card 1520 to the external switch 1620, through which an external network 1622 (e.g., the Internet) can be accessed. The signal lines 1614 and 1624 are “active” in FIG. 16, where the network switch cards 1510 and 1520 are capable of actually transmitting data to the external switches 1610 and 1620 at any time. A signal line 1616 connects the network switch card 1520 to the external switch 1610. A signal line 1626 connects the network switch card 1510 to the external switch 1620. The signal lines 1616 and 1626 are not “active,” or in a “stand-by” mode in FIG. 16. Thus, in FIG. 16, the network switch cards 1510 and 1520 are connected to the external networks 1612 and 1622, respectively, in the active mode.

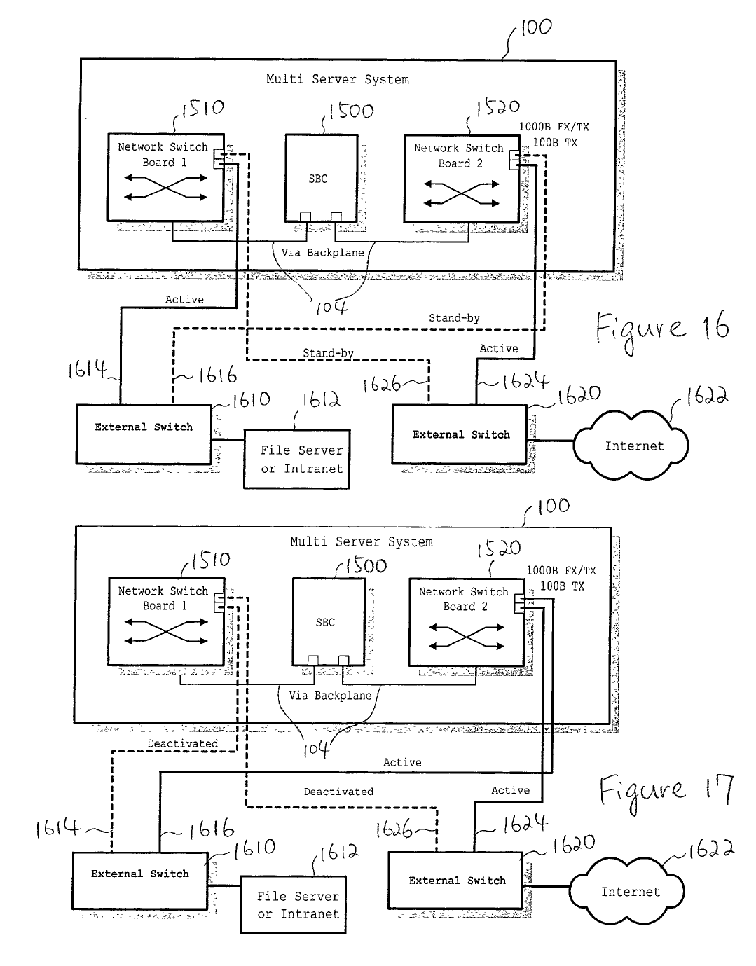

FIG. 17 is a block diagram of the embodiment of FIG. 15 in a system failure state, where the network switch card 1510 does not function properly, and the network switch card 1520 backs up the function done by the network switch card 1510 during the normal operation. In the case of FIG. 17, the signal line 1614 is deactivated, and instead, the signal line 1616, which is in the stand-by mode in the case of FIG. 16, is activated. As a result, in FIG. 17, the network switch card 1520 is connected to both of the external networks 1612 and 1622 through the external switches 1610 and 1620, respectively, thus performing back-up functionality for the failed network switch card 1510. Therefore, the multi-server system 100 according to the present invention as described above referring to FIGS. 15-17 enables improved fault tolerance.

Exemplary configurations of the multi-server system according to the present invention will now be described below. Since the multi-server system of the invention offers a very scalable solution, any one of (i) a single unit of the multi-server system 100, (ii) multiple units of the system 100, and (iii) a rack (or even racks) of the units of the system 100 can be integrated as a system solution depending on the performance needed.

FIG. 18 is a front view of a multi-server system 1800 according to the present invention. The multi-server system 1800 includes a single unit of the multiserver system 100 described in the foregoing description. The multi-server system 1800 includes two external network ports 1802 for 1000Base-SX/LX/CX/TX, and four external network ports 1804 for 100Base-TX. The multi-server system 1800, which includes 20 single board computers 102, does not need a separate file server since the internal HDD can be used for booting and storage. The multi-server system 1800 is connected to the Internet/Intranet using 100Base-TX or 1000Base-SX/LX/CX/TX connections. The multi-server system 1800 is a solution for SOHOs or small ISPs, ASPs, MSPs, and dot-coms.

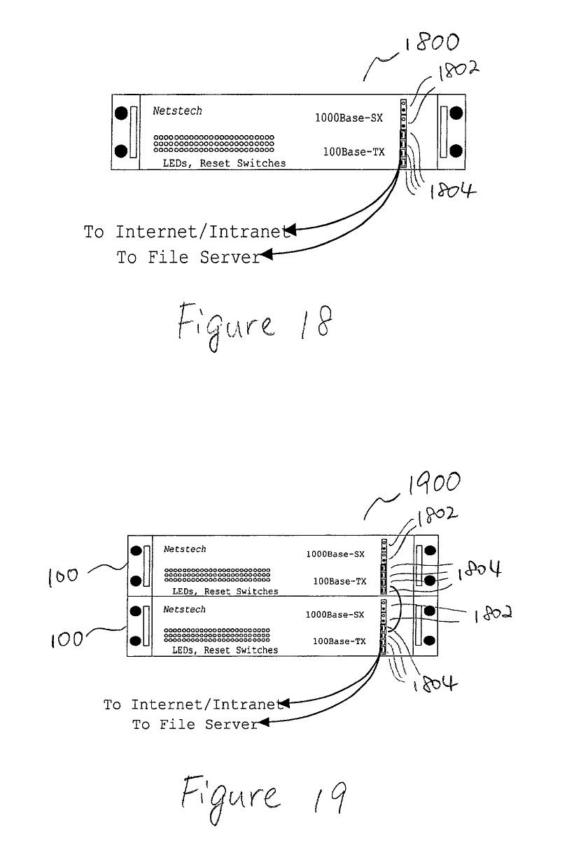

FIG. 19 is a front view of a multi-server system 1900 according to the present invention. The multi-server system 1900 includes two units of the multi-server system 100 described in the foregoing description. Each of the multi-server systems 100 includes two external network ports 1802 for 1000Base-SX/LX/CX/TX, and four external network ports 1804 for 100Base-TX. The two units of the multi-server system 100 can be daisy-chained using 100Base-TX or 1000Base-SX/LX/CX/TX connections by using the external network ports 1802 and 1804. The multi-server system 1900, which includes 40 single board computers 102, does not need a separate file server since the internal HDD can be used for booting and storage. The multi-server system 1900 is connected to the Intemet/Intranet using 100Base-TX or 1000Base-SX/LX/CX/TX connections. The multi-server system 1900 is a solution for SOHOs or small ISPs, ASPs, MSPs, and dot-coms.

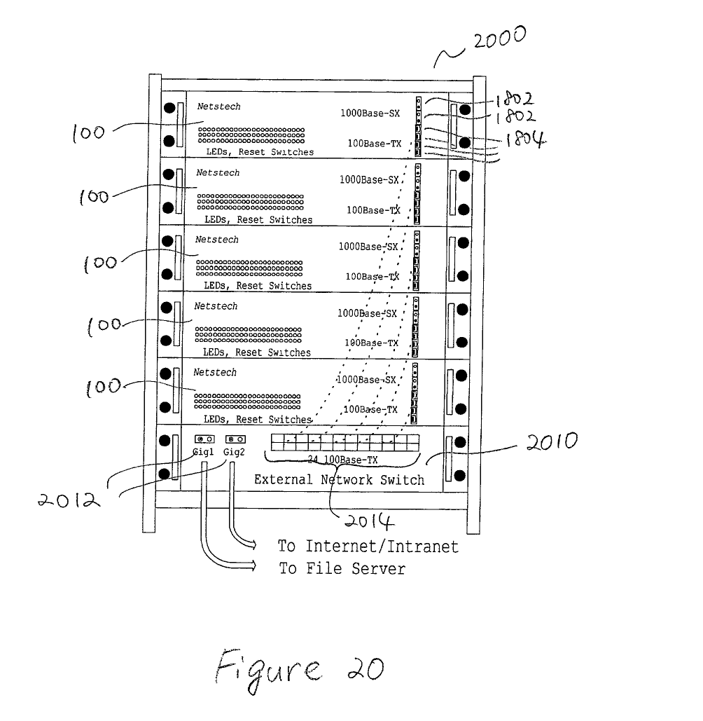

FIG. 20 is a front view of a multi-server system 2000 according to the present invention. The multi-server system 2000 includes five units of the multi-server system 100 described in the foregoing description. Each of the multi-server systems 100 includes two external network ports 1802 for 1000Base-SX, and four external network ports 1804 for 100Base-TX. The multi-server system 2000 includes an external network switch 2010 which is external to the multi-server systems 100. The external network switch 2010 selectively facilitates data transmissions among the multi-server systems 100 and at least one external server external to the multi-server system 2000.

The external network switch 2010 includes two external network ports 2012, which are selected from a group comprising ports for 1000Base-SX, 1000Base-LX, and 1000Base-CX. The external network switch 2010 also includes 24 external network ports 2014 for 100Base-TX. The five multi-server systems 100 are connected to the external network switch 2010 using the 100Base-TX media as illustrated by dotted lines in FIG. 20. The external network switch 2010 is connected to at least one external server external to the multi-server system 2000 or the Internet/Intranet via the external network ports 2012 using 1000Base-SX/LX/CX/TX connections. The multi-server system 2000 is a solution for mediumsize ISPs, ASPs, MSPs, and dot-coms and enterprises.

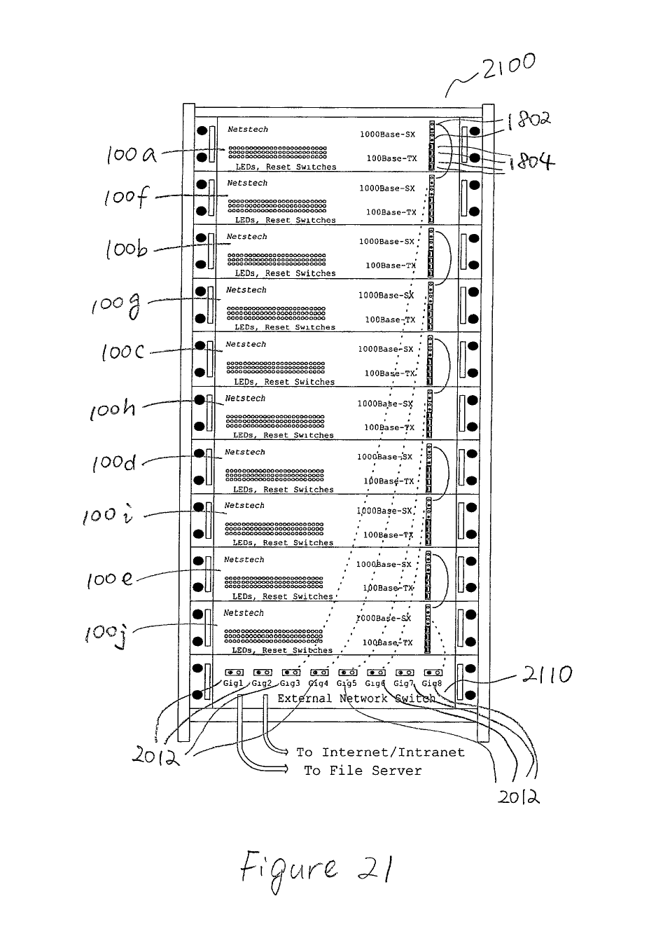

FIG. 21 is a front view of a multi-server system 2100 according to the present invention. The multi-server system 2100 includes ten units of the multi-server systems 100a-100j (collectively referred to as “100”). Each of the multi-server systems 100a-100j is the same as the multi-server system 100 described in the foregoing description. Each of the multi-server systems 100 includes two external network ports 1802 for 1000Base-SX/LX/CX/TX, and four external network ports 1804 for 100Base-TX. The multi-server system 2100 includes an external network switch 2110 which is external to the multi-server systems 100. The external network switch 2110 selectively facilitates data transmissions among the multi-server systems 100 and at least one external server external to the multi-server system 2100.

The external network switch 2110 includes ten external network ports 2012, which are selected from a group comprising ports for 1000Base-SX, 1000Base-LX, and 1000Base-CX. The multi-server systems 100a-100e are connected to the multi-server systems 100f-100j, respectively, using the 1000Base-SX media as illustrated by solid lines in FIG. 21. The multi-server systems 100f-100j are connected to the external network switch 2110 using 100Base-TX connections as illustrated by dotted lines in FIG. 21. The external network switch 2110 is connected to at least one external server external to the multi-server system 2100 or the Internet/Intranet via the external network ports 2012 using 1000Base-SX/LX/CX/TX connections. The multi-server system 2100 is a solution for large-size ISPs, ASPS, MSPs, and dot-coms and enterprises.

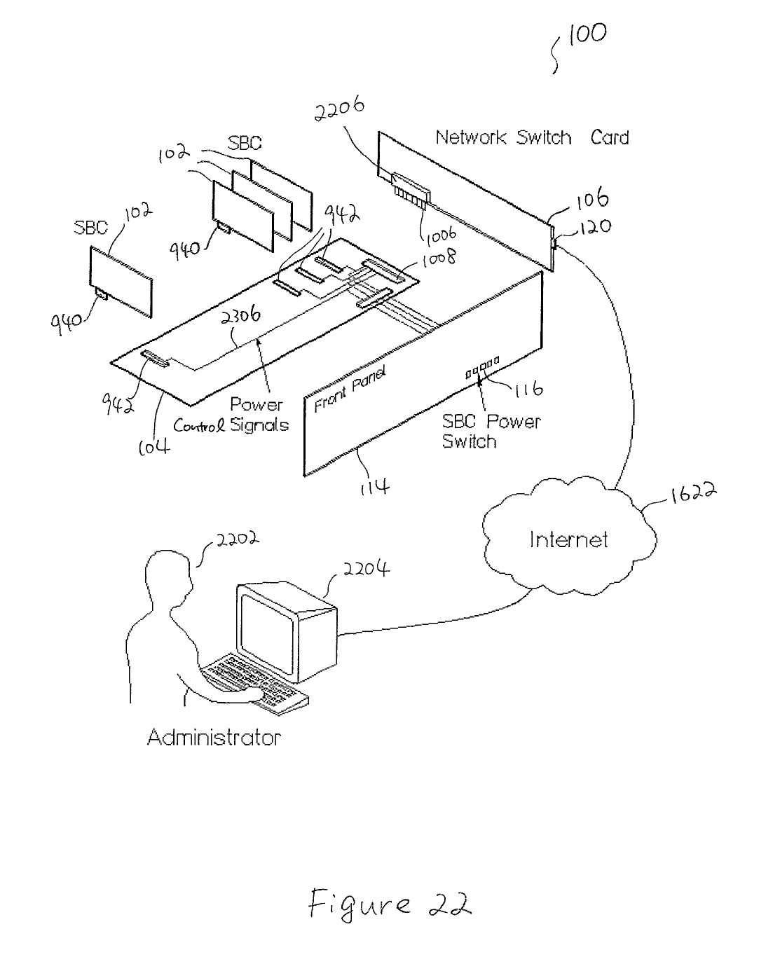

FIG. 22 is a diagram illustrating how to reset the single board computers selectively by a remote manager in the embodiments of the multi-server system according to the present invention. Sometimes, there are needs to reset a power of one of the single board computers (SBCs) 102 when the SBC 102 does not function properly due to a problem associated with, for example, input/output devices, memory management, the kernel of the operating system. In an embodiment illustrated in FIG. 22 according to the present invention, a human administrator 2202 is capable of controlling of any of the SBCs 102 by inputting a command into a computer 2204 through the Internet 1622, and the network switch card 106. In other words, in this embodiment, the administrator 2202 does not have to take the trouble of going over to the physical location where the faulty SBC is located.

The multi-server system 100 shown in FIG. 22 includes a decoding logic circuitry 2206 for SBC power resetting. The decoding logic circuitry 2206 for power resetting is provided on the network switch card 106 in this specific embodiment. For the purpose of manually resetting power of each of the SBCs 102, a set of microswitches 116 are provided on the front panel 114.

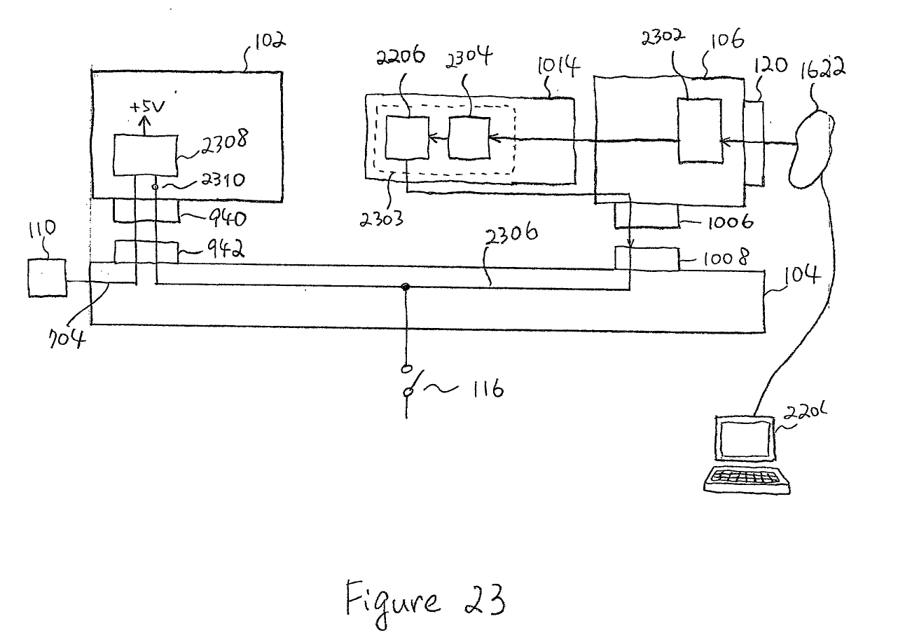

FIG. 23 is a block diagram of the remote power resetting control for use with the multi-server system 100. In the normal operation state, a data latch 2304 stores a default data, which does not invoke a power-off to any of the SBCs 102. A power control circuitry 2303 for controlling electric power supplied to one of the SBCs 102 includes the decoding logic circuitry 2206 and a data latch 2304.

When the administrator 2202 needs to turn off the power of a specific SBC 102 from a remote location, the administrator 2202 writes a specific data (e.g., a word) on a specific memory location (e.g., a register, or the data latch 2304) of the management CPU board 1014 through the Internet 1622. An Ethernet controller 2302 in the network switch card 106 receives the data for the power-off from the computer 2204 through the Internet 1622 and the external network port 120, and passes the data to the management CPU board 1014. The management CPU board 1014 then writes the data into the data latch 2304. A data bit in the data written in the data latch 2304 represents a power status (e.g., ON or OFF) for a SBC 102. Thus, for example, a two-byte (i.e., 16 bits) word defines the ON/OFF status for 16 SBCs 102 since values “1” and “0” in each of the bits corresponds to the ON and OFF status for each SBC 102.

The decoding logic circuitry 2206 provided on the management CPU board 1014 decodes the data bit on in the data latch 2304 periodically to check whether a power reset signal should be sent to the specific SBC 102 corresponding to the data bit. If the decoding logic circuitry 2206 decides to turn off the power of the SBC 102, then the decoding logic circuitry 2206 changes the state of a power control line 2306. The state of the power control line 2306 is either of HIGH or LOW levels. The power control line 2306 provided in the back plane 104 transmits the state of HIGH or LOW to a power regulator 2308.

Each of the SBCs 102 includes the power regulator 2308 which has a power control input 2310. The power regulator 2308 supplies electric power to components on the SBC 102 from the power supply 110 through the power line 704, and is capable of turn on/turn off the electric power to the SBC 102 based on the state at the power control input 2310. The power control input 2310 receives the state of the power control line 2306, and the state of the reset switch 116. Thus, the power regulator 2308 can turn on/turn off the SBC 102 by manually manipulating the reset switch 116, or by writing the data in the data latch 2304 in the management CPU board 1014 through the Internet 1622 from a remote location. Conversely, when the SBC 102 needs to be turned on, the administrator 2202 writes the default word into the data latch 2304 through the Internet 1622.

It will be understood that the decoding logic circuitry 2206, and the data latch 2304 may be located in places other than the management CPU board 1014. For example, the decoding logic circuitry 2206 can be provided on the network switch card 106 as shown in FIG. 22. While the management CPU board 1014 is separate from the network switch card 106 in this specific embodiment as illustrated in FIG. 23, the management CPU board 1014 can be integrated onto the network switch card 106.

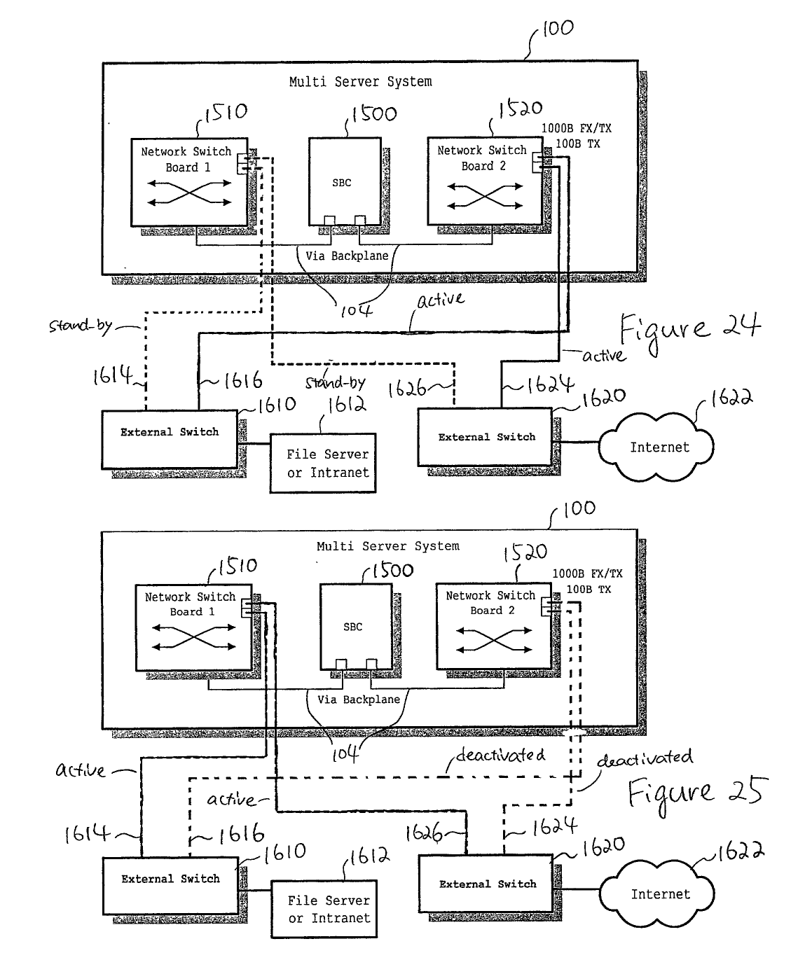

A still another embodiment of the multi-server system 100 of the present invention will now be described referring to FIGS. 24 and 25.

FIG. 24 is a block diagram of the embodiment of FIG. 15 in the normal operation state. The multi-server system 100 includes the single board computers 1500, and the network switch cards 1510 and 1520. External switches 1610 and 1620 are switches external to the multi-server system 100 for connection to the Internet and the Intranet. In the embodiment of FIG. 24, the single board computers 1500 communicate with the two network switch cards 1510 and 1520 through the back plane 104. A signal line 1616 connects the network switch card 1520 to the external switch 1610, through which an external network 1612 (e.g., a file server or the Intranet) can be accessed. A signal line 1624 connects the network switch card 1520 to the external switch 1620, through which an external network 1622 (e.g., the Internet) can be accessed. The signal lines 1616 and 1624 are “active” in FIG. 24, where the network switch card 1520 actually transmits data to the external switches 1610 and 1620, and the network card 1510 is in a “stand-by” mode for failure of the network switch card 1520. A signal line 1614 connects the network switch card 1510 to the external switch 1610. A signal line 1626 connects the network switch card 1510 to the external switch 1620. The signal lines 1614 and 1626 are not “active,” or in a “stand-by” mode in FIG. 24. Thus, in FIG. 24, the network switch card 1520 is connected to the external networks 1612 and 1622 in the active mode.

FIG. 25 is a block diagram of the embodiment of FIG. 15 in a system failure state, where the network switch card 1520 does not function properly, and the network switch card 1510 backs up the function done by the network switch card 1520 during the normal operation. In the case of FIG. 25, the signal lines 1616 and 1624 are deactivated, and instead, the signal lines 1614 and 1626, which are in the stand-by mode in the case of FIG. 24, are activated. As a result, in FIG. 25, the network switch card 1510 is connected to both of the external networks 1612 and 1622 through the external switches 1610 and 1620, respectively, thus performing back-up functionality for the failed network switch card 1520. Therefore, the multiserver system 100 according to the present invention as described above referring to FIGS. 15 and 24-25 enables improved fault tolerance.

While the embodiment employs the Ethernet protocol for data transmissions, it will be understood that the multi-server system 100 according to the present invention may utilize any network switching technologies, e.g., the ATM protocol, for data transmissions. In such a case, the single board computers 102, the back plane 104, and the network switch card 106 facilitate data transmissions using the ATM protocol.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A server comprising:
a plurality of single board computers;
a network interface for each of the single board computers;
network switching circuitry for selectively facilitating data transmissions among the plurality of single board computers through the network interfaces; and
a housing for enclosing the plurality of single board computers, and the network switching circuitry.

2. The server of claim 1, wherein the network switching circuitry communicates with the plurality of the single board computers through at least one back plane.

3. The server of claim 2, wherein the back plane comprises a printed circuit board comprising two power planes which supply electrical power, and two signal planes which communicate data, the two power planes being disposed between the two signal planes.

4. The server of claim 1, wherein the network switching circuitry facilitates the data transmissions using the Ethernet protocol.

5. The server of claim 1, further comprising at least one external network port for communicating with other servers external to the housing.

6. The server of claim 5, wherein the network switching circuitry facilitates data transmissions with the other servers via the at least one external network port using the Ethernet protocol.

7. The server of claim 6, wherein the at least one external network port comprises a 100Base-TX port.

8. The server of claim 6, wherein the at least one external network port comprises at least one of a 1000Base-SX port, a 1000Base-LX port, a 1000Base-CX port, and a 1000Base-TX port.

9. The server of claim 2, wherein the plurality of single board computers are arranged on the at least one back plane in at least one row of parallel single board computers, and wherein the network switching circuitry is disposed on a network card which is coupled to the at least one back plane.

10. The server of claim 9, wherein the at least one back plane comprises a first back plane on which at least some of the parallel single board computers are disposed, the network card being substantially parallel to the parallel single board computers.

11. The server of claim 9, wherein the at least one back plane comprises multiple back planes, and the at least one row of single board computers comprises multiple rows of single board computers, each of the back planes having at least one of the multiple rows of single board computers disposed thereon, the network card being coupled to the multiple back planes.

12. The server of claim 11, wherein one of the multiple back planes is coupled to an end of the network card, and another of the multiple back planes is coupled to another end of the network card opposite to the end of the network card.

13. The server of claim 1, wherein each network interface comprises an Ethernet controller, and an associated Ethernet transceiver, each Ethernet controller facilitating the data transmissions through the associated Ethernet transceiver, each Ethernet transceiver being coupled to the network switching circuitry through a transformer.

14. The server of claim 1, wherein the network interface comprises an Ethernet controller, and an associated Ethernet transceiver, each Ethernet controller facilitating the data transmissions through the associated Ethernet transceiver, each Ethernet transceiver being coupled to the network switching circuitry through a capacitor.

15. The server of claim 14, wherein the capacitor for each Ethernet transceiver is disposed on a corresponding one of the plurality of single board computers.

16. The server of claim 14, wherein the capacitor for each Ethernet transceiver is disposed on a back plane through which the data transmissions are transmitted.

17. The server of claim 1, wherein the network interface comprises an Ethernet controller, and an associated data buffer, each Ethernet controller facilitating the data transmissions through the associated data buffer, each data buffer being directly coupled to the network switching circuitry without an Ethernet transceiver.

18. The server of claim 17, wherein the data buffer for each Ethernet transceiver is disposed on a corresponding one of the plurality of single board computers.

19. The server of claim 17, wherein the data buffer for each Ethernet transceiver is disposed on a back plane through which the data transmissions are transmitted.

20. The server of claim 1, wherein the network interface comprises an Ethernet controller, each Ethernet controller facilitating the data transmissions through the back plane, each Ethernet controller being directly coupled to the network switching circuitry without an Ethernet transceiver.

21. The server of claim 1, further comprising:
a heat pipe thermally coupled to at least one central processing unit (CPU) on at least one of the single board computers; and
a plurality of cooling fins thermally coupled to the heat pipe.

22. The server of claim 21, wherein an axis of the heat pipe is substantially normal to the plurality of the cooling fins.

23. The server of claim 21, further comprising a cooling fan which provides a cooling airflow over the plurality of the cooling fins in a direction substantially parallel to the plurality of the cooling fins.

24. The server of claim 23, further comprising an air duct, wherein the cooling fins are aligned within the air duct.

25. A server architecture comprising multiple instances of the server of claim 6, interconnected via the at least one external network port of each.

26. The server architecture of claim 25, wherein the multiple instances of the server communicate with each other using the at least one external network port of each and the Ethernet protocol.

27. The server architecture of claim 26, wherein the at least one external network port comprises a 100Base-TX port.

28. The server architecture of claim 25, further comprising external network switching circuitry which is external to the housings of the multiple instances of the server for selectively facilitating data transmission among the multiple instances of the server and at least one external server external to the server architecture.

29. The server architecture of claim 28, wherein at least five of the servers are connected to the external network switching circuitry using the Ethernet protocol.

30. The server architecture of claim 29, wherein each of the at least five of the servers comprises a 100Base-TX port.

31. The server architecture of claim 28, wherein at least five of the servers are connected to at least other five of the servers using the Ethernet protocol; and the at least five of the servers are connected to the external network switching circuitry using the Ethernet protocol.

32. The server architecture of claim 31, wherein each of the at least five of the servers comprises at least one of a 1000Base-SX port, a 1000Base-LX port, a 1000Base-CX port, and a 1000Base-TX port.

33. The server of claim 1, further comprising another network switching circuitry for selectively facilitating data transmissions among the plurality of single board computers through the network interfaces, wherein
when the network switching circuitry and the another network switching circuitry function properly; the network switching circuitry and the another network switching circuitry facilitate data transmissions with first and second external devices, respectively, the first and second external devices being external to the server, and
when the another network switching circuitry does not function properly; the network switching circuitry facilitates data transmissions with the first and second external devices.

34. The server of claim 33, further comprising a first external switching circuitry and a second external switching circuitry which are external to the server, wherein
when the network switching circuitry and the another network switching circuitry function properly; the first external switching circuitry facilitates data transmissions between the network switching circuitry and the first external device, and the second external switching circuitry facilitates data transmissions between the another network switching circuitry and the second external device, and
when the another network switching circuitry does not function properly; the first external switching circuitry facilitates data transmissions between the network switching circuitry and the first external device, and the second external switching circuitry facilitates data transmissions between the network switching circuitry and the second external device.

35. The server of claim 1, further comprising another network switching circuitry for selectively facilitating data transmissions among the plurality of single board computers through the network interfaces, wherein
when the network switching circuitry functions properly; the network switching circuitry facilitates data transmissions with first and second external devices, the first and second external devices being external to the server, and
when the network switching circuitry does not function properly; the another network switching circuitry facilitates data transmissions with the first and second external devices.

36. The server of claim 35, further comprising a first external switching circuitry and a second external switching circuitry which are external to the server, wherein
when the network switching circuitry functions properly; the first external switching circuitry facilitates data transmissions between the network switching circuitry and the first external device, and the second external switching circuitry facilitates data transmissions between the network switching circuitry and the second external device, and
when the network switching circuitry does not function properly; the first external switching circuitry facilitates data transmissions between the another network switching circuitry and the first external device, and the second external switching circuitry facilitates data transmissions between the another network switching circuitry and the second external device.

37. The server of claim 5, further comprising a power control circuitry which receives a data through the external network port, the power control circuitry being capable of controlling electrical power supplied to at least one of the plurality of single board computers based on the data.

38. The server of claim 37, wherein the power control circuitry is capable of controlling electrical power supplied to any one of the plurality of single board computers based on the data.

39. The server of claim 38, wherein the power control circuitry includes a data latch, and a decoding logic circuitry.
